(19) United States
(12) Patent Application Publication
(10) Pub. No.: US 2025/0206266 A1
(43) Pub. Date: Jun. 26, 2025

(54) WINDSHIELD WIPER ASSEMBLY

(71) Applicant: Rosemount Aerospace Inc., Burnsville, MN (US)

(72) Inventors: Vishwanath Hitnalli, Bangalore (IN); Phani Srinivas Nouduri, Karnataka (IN)

(21) Appl. No.: 18/927,261

(22) Filed: Oct. 25, 2024

(30) Foreign Application Priority Data
Dec. 20, 2023 (IN) 202341087293

(51) Int. Cl. B60S 1/38; B60S 1/04; B60S 1/40

(52) U.S. Cl. CPC B60S 1/3849; B60S 1/0408; B60S 1/4087

(57) ABSTRACT

A windshield wiper system includes an arm hub connected to a drive shaft, a curved cantilever beam connected to the arm hub, and an elastomeric wiper blade element. The curved cantilever beam has a cross-sectional shape. The elastomeric wiper blade element includes a mounting channel shaped to engage with the cross-sectional shape of the curved cantilever beam such that the elastomeric wiper blade element can be installed on the curved cantilever beam.

### CROSS-REFERENCE TO RELATED APPLICATION(S)

This application claims the benefit of India Provisional Application No. 202341087293 filed Dec. 20, 2023 for “WINDSHIELD WIPER ASSEMBLY,” which is incorporated into this application by reference in its entirety.

### BACKGROUND

The present disclosure relates generally to windshield wiper systems and, more particularly, to windshield wiper systems for use in aerospace applications.

As well known, windshield wiper systems are used in many applications to clear rain, frozen precipitation, dirt and other debris from windshields. While windshield wiper systems used in aerospace applications (e.g., for various aircraft and helicopters) have this same basic functionality, they have some desirable additional requirements, including but not limited to lower weight and aerodynamic design considerations.

### SUMMARY

One aspect of this disclosure is directed to a windshield wiper system that includes an arm hub connected to a drive shaft, a curved cantilever beam connected to the arm hub, and an elastomeric wiper blade element. The curved cantilever beam has a cross-sectional shape. The elastomeric wiper blade element includes a mounting channel shaped to engage with the cross-sectional shape of the curved cantilever beam such that the elastomeric wiper blade element can be installed on the curved cantilever beam.

Another aspect of this disclosure is directed to a method of installing a windshield wiper system that includes connecting a drive shaft to a drive motor, connecting an arm hub to the drive shaft, securing a curved cantilever beam to the arm hub, and sliding a mounting channel of an elastomeric wiper blade element over the curved cantilever beam. The curved cantilever beam has a cross-sectional shape. The mounting channel is shaped to engage with the cross-sectional shape of the curved cantilever beam.

### BRIEF DESCRIPTION OF THE DRAWINGS

FIG. 1 is schematic view of a prior art windshield wiper system.

FIG. 2 is schematic view of an embodiment of a windshield wiper system of this disclosure.

FIG. 3 is an exploded view of the windshield wiper system of FIG. 2.

FIG. 4 is a close-up view of a portion of the windshield wiper system of FIG. 2 showing a cantilever beam and wiper element.

FIG. 5 is a graphical depiction the initial curvature shape of the cantilever beam of the windshield wiper system of FIG. 2.

FIG. 6 is a schematic view of the windshield wiper system of FIG. 2 depicting the cantilever beam and wiper element is an as-built configuration and an as-installed configuration.

FIG. 7 is another schematic view of the windshield wiper system of FIG. 2 depicting the cantilever beam and wiper element is an as-built configuration and an as-installed configuration.

FIG. 8 is a schematic view of the windshield wiper system of FIG. 2 installed on a representative windshield.

### DETAILED DESCRIPTION

Windshield wiper systems are used in many applications, including terrestrial, nautical, and aerospace applications, to clear rain, frozen precipitation, dirt and other debris from windshields. Terrestrial applications include every type of motor vehicle, rail vehicles, etc. Nautical applications include every type of ship. Aerospace applications include every type of aircraft, including fixed wing and rotary wing aircraft.

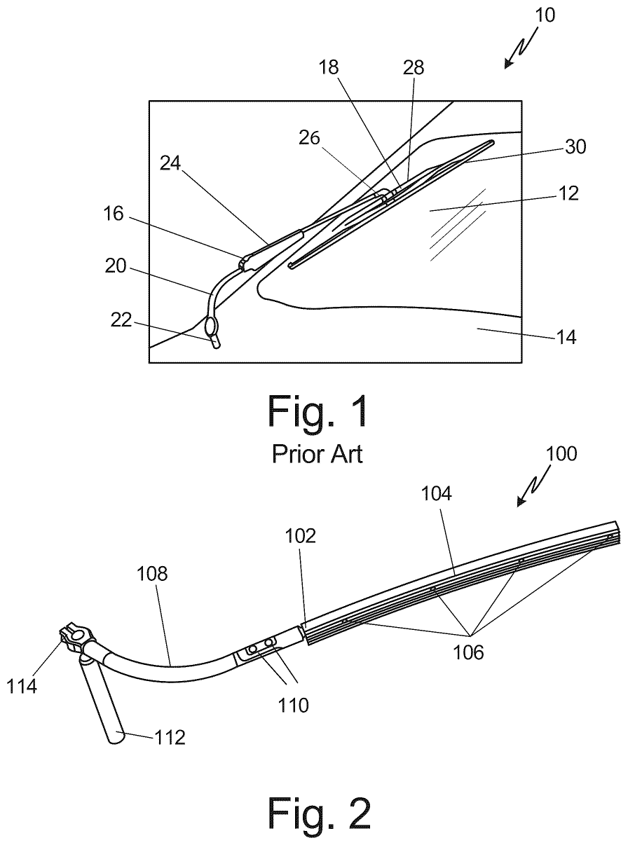

FIG. 1 shows a schematic view of a current windshield wiper system 10 positioned on a windshield 12 of a vehicle 14. The vehicle 14 may any sort of vehicle that can benefit from the functionality of the windshield wiper system 10 as discussed above. The windshield wiper system 10 typically includes a motor converter (not shown), a wiper arm assembly 16, a wiper blade assembly 18, and, optionally, a wash system (not shown). The wiper arm assembly 16 includes a lower arm 20 connected to shaft 22, which in turn is connected to the motor converter (not shown). The lower arm 20 is connected to an upper arm 24 that supports the wiper blade assembly 18. While the connection between the upper arm 24 and the wiper blade assembly 18 can take many forms, in the embodiment shown in FIG. 1 the upper arm 24 connects to the wiper blade assembly 18 at a mid-blade assembly location using a saddle and pin connector means 26. The wiper blade assembly 18 includes a bridge 28 and a wiper blade 30. A desired wiper blade load on the windshield 12 is set by a spring (not shown) in the wiper arm assembly 16. As known, the windshield wiper system 10 should provide sufficient load on the wiper blade assembly 18 to keep the wiper blade 30 in contact with the windshield 12 during all relevant phases of operation to ensure that the wiper blade 30 effectively cleans the windshield 12.

While windshield wiper systems used in aerospace applications have the same basic functionality of any windshield wiper system, they have some desirable additional requirements, including but not limited to lower weight and aerodynamic design considerations. Redesigning the windshield wiper system to reduce part count and simplify wiper blade installation can achieve both goals of decreasing overall windshield wiper system weight and reducing aerodynamic drag.

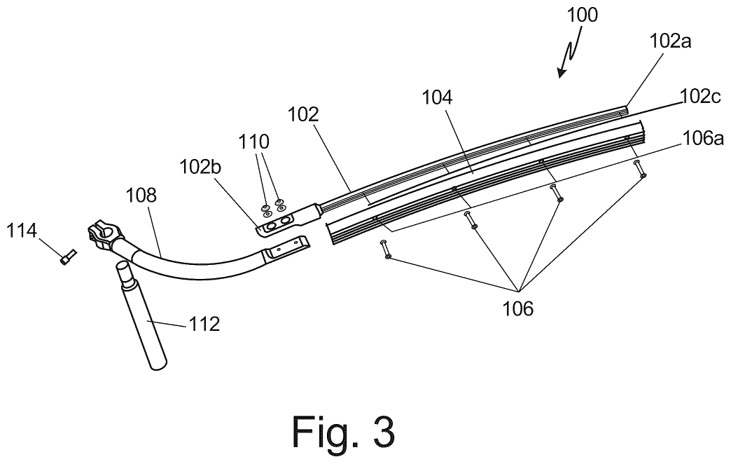

As shown in FIG. 2, such a redesigned windshield wiper system 100 includes a cantilever beam 102 that holds an elastomeric wiper blade element 104. In this embodiment, the elastomeric wiper blade element 104 acts as a wiping element without having a separate wiper blade assembly as depicted in FIG. 1. The elastomeric wiper blade element 104 is secured to the cantilever beam with blade element fasteners 106. The blade element fasteners 106 can be rivets as shown in FIGS. 2 and 3 or any other suitable fastener known in the art. The cantilever beam 102 is connected to an arm hub 108 using two or more cantilever beam fasteners 110. The cantilever beam fasteners 110 can be rivets, as shown in FIGS. 2 and 3, screws, nut and bolts, or any other suitable fastener known in the art. The arm hub 108 is connected to a drive shaft 112, which in turn is connected to a drive motor (not shown). Hub fastener 114 secures the arm hub 108 to the drive shaft 112. The hub fastener 114 can be a screw as shown in FIGS. 2 and 3, or any other suitable fastener known in the art. Wiper blade element 104 is configured to slide over or otherwise attach to the cantilever beam 102 and secured to the cantilever beam 102 with the blade element fasteners 106.

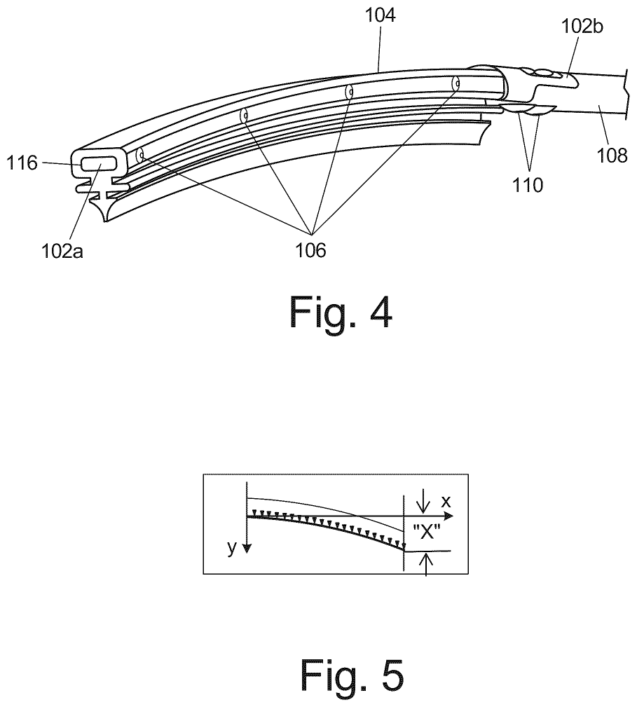

FIG. 3 is an exploded view of the windshield wiper system 100, showing additional detail of the assembly of the windshield wiper system 100. Cantilever beam 102 includes a beam section 102a and a fastener section 102b. Beam section 102a is configured to receive the wiper blade element 104 that slides over or is otherwise attached to the cantilever beam 102. As shown in more detail in FIG. 4, the wiper blade element 104 includes a mounting channel 116 that is shaped to have a snug fit over the beam section 102a. In the context of this application, “snug fit” means a close fit that permits assembly by hand with limited movement between the wiper blade element 104 and beam section 102a after assembly. As shown, the mounting channel 116 can conform in shape to the cross-section of the beam section 102a, such as with a rectangular cross-section or any other cross-section deemed useful for a particular application. As a person of ordinary skill would appreciate, a rectangular cross-section (or a cross-section other than a circular cross-section) can be a mistake proofing feature to support desired alignment of the wiper blade element 104 with regard to the overall windshield wiper system 100 and to act as an anti-rotational feature to prevent the wiper blade element 104 from rotating around the beam section 102a. In one embodiment, the wiper blade element 104 and the mounting channel 116 extend for the full length of the beam section 102a so that when the wiper blade element 104 is installed on the beam section 102a, the mounting channel 116 engages all or substantially all of the beam section 102a.

As discussed above, the wiper blade element 104 can be secured to the beam section 102a with blade element fasteners 106. As shown in FIG. 3, in one embodiment a plurality of blade element fasteners 106 are configured to pass through a corresponding plurality of blade element fastener holes 106a in the wiper blade element 104 and a corresponding plurality of beam section fastener holes 102c in the beam section 102a to secure the wiper blade element 104 to the beam section 102a. The blade element fasteners 106 can be any type of fastener deemed suitable to keep the wiper blade element 104 attached to the beam section 102a during all operational conditions while permitting removal at an appropriate time to replace a worn wiper blade element 104 with a new wiper blade element 104. Similarly, the blade element fasteners 106 can be made from any materials deemed suitable to permit the blade element fasteners 106 to perform their intended function. Although FIG. 3 depicts four blade element fasteners 106, a windshield wiper system 100 can have more or fewer blade element fasteners as deemed appropriate for a particular application.

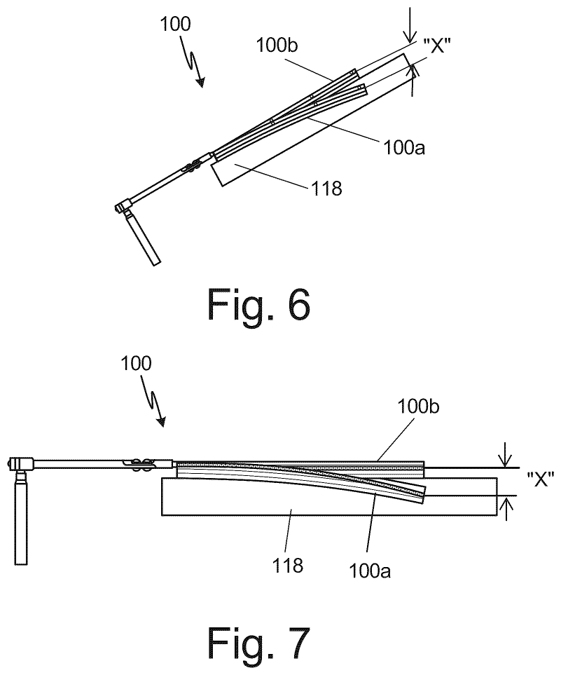

The cantilever beam 102 is designed to be manufactured with a curved shape that is selected to straighten when the windshield wiper system 100 is installed such that the cantilever beam 102 exerts a load sufficient to keep the wiper blade element 104 in contact with a windshield 118 (see FIGS. 6, 7, and 8) during all operational conditions. As shown in FIG. 5, the cantilever beam 102 has an initial deflection, “X,” that is selected during a design phase to provide a desired blade load after installation with the wiper blade element 104 in the windshield wiper system 100. The initial curvature shape of the cantilever beam 102 and the slope of the curvature are selected to provide a uniform load distribution along the length of the cantilever beam 102 after installation with the wiper blade element 104 in the windshield wiper system 100. A person of ordinary skill will know how to select the desired load for the cantilever beam 102 based on the size and shape of the wiper system 100, including the wiper blade element 104, and the expected operational conditions for the wiper system 100.

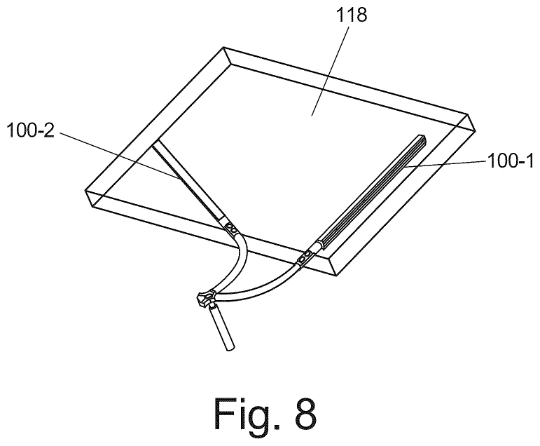

FIGS. 6 and 7 show the wiper system 100 in an as built condition 100a (i.e., with the cantilever beam 102 curved) and in an as installed condition 100b (i.e., with the cantilever beam straightened and the wiper blade element in contact with the windshield 118). Both FIGS. 6 and 7 show the initial deflection, “X,” in the as built condition 100a versus the as installed condition 100b. FIG. 8 shows the wiper system 100 in two different operational positions 100-1 and 100-2 as it moves across the windshield 118.

As discussed above, cantilever beam 102 is manufactured with an initial deflection, “X,” that is selected during a design phase to provide a desired blade load after installation with the wiper blade element 104 in the windshield wiper system 100. Cantilever beam 102 can be made from any material deemed suitable for its intended use—that is a material that can provide the desired blade load and be durable enough to service a desired number of duty cycles when used as intended. Beam section 102a can be any desired length and, as discussed above, can have any desired cross-sectional shape. Fastener section 102b can have any design that can securely attach the cantilever beam 102 to the arm hub 108. For example, fastener section 102b can have a flat portion that is secured to the arm hub 108 using two or more cantilever beam fasteners 110 as shown in FIG. 3. Alternately, fastener section 102b can have any other design deemed suitable to secure the cantilever beam 102 to the arm hub 108, such as a shaped sleeve to fit onto the arm hub 108 or any other suitable design. Depending on the design of fastener section 102b, any number of cantilever beam fasteners 110 of any design can be used. Depending on the design of fastener section 102b, the cantilever beam fasteners 110 can be optional or omitted entirely as long as the fastener section 102b is securely attached to the arm hub 108.

The elastomeric wiper blade element 104 can be made from any material suitable for its primary intended function, which is to clear rain, frozen precipitation, dirt and other debris windshield 118. For example, the elastomeric wiper blade element 104 can be made from natural or artificial rubber, a polyurethane material, or any other elastomeric material deem suitable for the application. As discussed above, wiper blade 104 includes mounting channel 116 that is shaped to have a snug fit over the beam section 102a. As shown in FIG. 4, the mounting channel 116 can conform in shape to the cross-section of the beam section 102a, such as with a rectangular cross-section or any other cross-section deemed useful for a particular application. The elastomeric wiper blade element 104 is secured to the cantilever beam with blade element fasteners 106. The blade element fasteners 106 can be rivets as shown in FIGS. 2, 3, and 4 or any other suitable fastener known in the art. While FIGS. 2, 3, and 4 show four blade element fasteners 106 securing the wiper blade element 104 to the cantilever beam 102, a person of ordinary skill will appreciate that any number of blade element fasteners 106 can be used. Alternately, depending on the design of the cantilever beam 102 and the wiper blade element 104, it is conceivable that the windshield wiper system 100 can be constructed without any blade element fasteners 106.

A person of ordinary skill will appreciate that windshield wiper system 100 can be used for a variety of applications, including but not limited to terrestrial applications (e.g., every type of motor vehicle, rail vehicles, etc.), nautical applications (e.g., every type of ship or vessel), and aerospace applications (e.g., every type of aircraft, including fixed wing and rotary wing aircraft). At least for aerospace applications, it can be desirable to design the windshield wiper system 100 to be aerodynamically efficient to reduce drag related to the windshield wiper system 100 and to support desired operation of the windshield wiper system 100 with airflows associated with aircraft operation.

The windshield wiper system of this disclosure uses the curved structure of the cantilever beam to provide a desired uniform load along the length of the wiper blade element as it engages with the windshield. The disclosed windshield wiper system includes a reduced number of components compared to current windshield wiper systems that rely on a wiper arm assembly to impart a desired load on the wiper blade. Depending on the design of the disclosed windshield wiper system, the length of the combined arm hub and cantilever beam can be particularly useful if the drive shaft and drive motor create a pivot point close to the windshield. The reduced number of components can result a weight reduction compared to current windshield wiper systems. The lower weight of the disclosed windshield wiper system can reduce the torque requirements of the drive motor. The drive motor torque requirements can be further reduced by using an aerodynamically efficient design (i.e., a low drag design) for the windshield wiper system.

### Discussion of Possible Embodiments

The following are non-exclusive descriptions of possible embodiments of the present invention.

A windshield wiper system comprises an arm hub connected to a drive shaft, a curved cantilever beam connected to the arm hub, and an elastomeric wiper blade element. The curved cantilever beam has a cross-sectional shape. The elastomeric wiper blade element includes a mounting channel shaped to engage with the cross-sectional shape of the curved cantilever beam such that the elastomeric wiper blade element can be installed on the curved cantilever beam.

The windshield wiper system of the preceding paragraph can optionally include, additionally and/or alternatively, any one or more of the following features, configurations and/or additional elements:

The windshield wiper system of the preceding paragraph, wherein the curved cantilever beam includes a fastener section configured to secure the curved cantilever beam securely to the arm hub.

The windshield wiper system of the preceding paragraph, wherein the fastener section is configured to engage with two or more cantilever beam fasteners to secure the curved cantilever beam securely to the arm hub.

The windshield wiper system of any of the preceding paragraphs, wherein the mounting channel is configured to provide a snug fit between the elastomeric wiper blade element and the curved cantilever beam.

The windshield wiper system of any of the preceding paragraphs, wherein the elastomeric wiper blade element is secured to the curved cantilever beam with one or more blade element fasteners.

The windshield wiper system of any of the preceding paragraphs, wherein the curved cantilever beam is configured to have a curved shape that is selected to straighten when the windshield wiper system is installed against a windshield such that the curved cantilever beam exerts a load sufficient to keep the wiper blade element in contact with the windshield during all operational conditions.

The windshield wiper system of the preceding paragraph, wherein the curved cantilever beam is further configured to provide a uniform load distribution along a length of the curved cantilever beam.

The windshield wiper system of any of the preceding paragraphs, wherein the windshield wiper system is configured for use in terrestrial applications.

The windshield wiper system of any of the preceding paragraphs, wherein the windshield wiper system is configured for use in nautical applications.

The windshield wiper system of any of the preceding paragraphs, wherein the windshield wiper system is configured for use in aerospace applications.

The windshield wiper system of the preceding paragraph, wherein the windshield wiper system has an aerodynamically efficient design that reduces aerodynamic drag.

A method of installing a windshield wiper system comprises connecting a drive shaft to a drive motor, connecting an arm hub to the drive shaft, securing a curved cantilever beam to the arm hub, and sliding a mounting channel of an elastomeric wiper blade element over the curved cantilever beam. The curved cantilever beam has a cross-sectional shape. The mounting channel is shaped to engage with the cross-sectional shape of the curved cantilever beam.

The method of the preceding paragraph can optionally include, additionally and/or alternatively, any one or more of the following features, configurations and/or additional elements:

The method of the preceding paragraph, wherein the curved cantilever beam includes a fastener section configured to secure the curved cantilever beam securely to the arm hub using two or more cantilever beam fasteners.

The method of any of the preceding paragraphs, wherein the mounting channel is configured to provide a snug fit between the elastomeric wiper blade element and the curved cantilever beam and the elastomeric wiper blade element is secured to the curved cantilever beam with one or more blade element fasteners.

The method of any of the preceding paragraphs, wherein the curved cantilever beam is configured to have a curved shape that is selected to straighten when the windshield wiper system is installed against a windshield such that the curved cantilever beam exerts a load sufficient to keep the wiper blade element in contact with the windshield during all operational conditions.

The method of the preceding paragraph, wherein the curved cantilever beam is further configured to provide a uniform load distribution along a length of the curved cantilever beam.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A windshield wiper system comprising:
an arm hub connected to a drive shaft;
a curved cantilever beam connected to the arm hub, wherein the curved cantilever beam has a cross-sectional shape; and
an elastomeric wiper blade element, wherein the elastomeric wiper blade element includes a mounting channel shaped to engage with the cross-sectional shape of the curved cantilever beam such that the elastomeric wiper blade element can be installed on the curved cantilever beam.

2. The windshield wiper system of claim 1, wherein the curved cantilever beam includes a fastener section configured to secure the curved cantilever beam securely to the arm hub.

3. The windshield wiper system of claim 2, wherein the fastener section is configured to engage with two or more cantilever beam fasteners to secure the curved cantilever beam securely to the arm hub.

4. The windshield wiper system of claim 1, wherein the mounting channel is configured to provide a snug fit between the elastomeric wiper blade element and the curved cantilever beam.

5. The windshield wiper system of claim 1, wherein the elastomeric wiper blade element is secured to the curved cantilever beam with one or more blade element fasteners.

6. The windshield wiper system of claim 1, wherein the curved cantilever beam is configured to have a curved shape that is selected to straighten when the windshield wiper system is installed against a windshield such that the curved cantilever beam exerts a load sufficient to keep the wiper blade element in contact with the windshield during all operational conditions.

7. The windshield wiper system of claim 6, wherein the curved cantilever beam is further configured to provide a uniform load distribution along a length of the curved cantilever beam.

8. The windshield wiper system of claim 1, wherein the windshield wiper system is configured for use in terrestrial applications.

9. The windshield wiper system of claim 1, wherein the windshield wiper system is configured for use in nautical applications.

10. The windshield wiper system of claim 1, wherein the windshield wiper system is configured for use in aerospace applications.

11. The windshield wiper system of claim 10, wherein the windshield wiper system has an aerodynamically efficient design that reduces aerodynamic drag.

12. A method of installing a windshield wiper system, comprising:
connecting a drive shaft to a drive motor;
connecting an arm hub to the drive shaft;
securing a curved cantilever beam to the arm hub, wherein the curved cantilever beam has a cross-sectional shape; and
sliding a mounting channel of an elastomeric wiper blade element over the curved cantilever beam, wherein the mounting channel is shaped to engage with the cross-sectional shape of the curved cantilever beam.

13. The method of claim 12, wherein the curved cantilever beam includes a fastener section configured to secure the curved cantilever beam securely to the arm hub using two or more cantilever beam fasteners.

14. The method of claim 12, wherein the mounting channel is configured to provide a snug fit between the elastomeric wiper blade element and the curved cantilever beam and the elastomeric wiper blade element is secured to the curved cantilever beam with one or more blade element fasteners.

15. The method of claim 12, wherein the curved cantilever beam is configured to have a curved shape that is selected to straighten when the windshield wiper system is installed against a windshield such that the curved cantilever beam exerts a load sufficient to keep the wiper blade element in contact with the windshield during all operational conditions.

16. The method of claim 15, wherein the curved cantilever beam is further configured to provide a uniform load distribution along a length of the curved cantilever beam.
